(19) United States
(12) Patent Application Publication
(10) Pub. No.: US 2012/0293705 A1
(43) Pub. Date: Nov. 22, 2012

(54) IMAGE PROCESSING METHOD

(75) Inventor: Yu-Hsiu Su, New Taipei City (TW)

(73) Assignee: ALTEK CORPORATION, Hsinchu City (TW)

(21) Appl. No.: 13/190,488

(22) Filed: Jul. 26, 2011

(30) Foreign Application Priority Data
May 19, 2011 (TW) 100117608

(51) Int. Cl. G03B 13/00

(52) U.S. Cl. 348/345

(57) ABSTRACT

A method for processing images, suitable for an image capturing apparatus, is provided. In the present invention, a first image is captured. And a face recognition is executed for the first image so as to locate a face location of the first image. A second image is captured after adjusting a imaging magnification, and the face recognition is executed for the second image so as to obtain a face image. Next, the face image obtained from the second image is set at the face location of the first image for generating a composite image.

### CROSS-REFERENCE TO RELATED APPLICATION

This application claims the priority benefit of Taiwan application serial no. 100117608, filed on May 19, 2011. The entirety of the above-mentioned patent application is hereby incorporated by reference herein and made a part of this specification.

### BACKGROUND OF THE INVENTION

1. Field of Invention

The present invention relates to an image processing method. More particularly, the present invention relates to an image processing method for processing images captured by variable-focus lens with different focal lengths.

2. Description of Related Art

With the development of the technologies, the image capturing apparatuses such as cameras and camcorders are essential to our daily life and the daily life and the working environment are the platforms for the image capturing apparatuses to show their functions. Since there are various image capturing apparatuses in the market, the variations of the functions of the image capturing apparatuses are the factors for the user to choose the image capturing apparatuses.

Currently, due to the developments of the social networks, people communicate with each other through the social networks and are used to using digital cameras to record daily life so as to share the pictures on the social networks. Therefore, the camera which can take a picture out of ordinary will attract the users' attentions.

### SUMMARY OF THE INVENTION

The present invention provides an image processing method using face recognition to generate a delightful composite image.

The invention provides an image processing method for an image capturing apparatus. A first image is captured. Then, a face recognition is executed on the first image to locate a face location in the first image. A second image is captured. The face recognition is executed on the second image to obtain a face image. The face image from the second image is set on the face location in the first image.

According to one embodiment of the present invention, the first image is captured while a lens of the image capturing apparatus is adjusted to a first focal length. The second image is captured while the lens of the image capturing apparatus is adjusted to a second focal length. The first focal length is a wide-angle focal length and the second focal length is a telescope focal length.

According to one embodiment of the present invention, after the step of executing the face recognition on the first image, whether the first image comprises a plurality of person images respectively corresponding to a plurality of persons is determined according to a number of face images recognized in the face recognition executed on the first image. When the number of the face images recognized in the face recognition executed on the first image is larger than or equal to two, a first facial feature corresponding to each of the person images in the first image is stored and the face location corresponding to each of the person images in the first image is stored.

According to one embodiment of the present invention, when the number of the face images recognized in the face recognition executed on the first image is larger than or equal to two, the second image of each of the persons is captured. After obtaining the face image from the second image, a second facial feature of the face image is stored.

According to one embodiment of the present invention, before the step of setting the face image on the face location in the first image, the second facial feature obtained from the second image is compared with the first facial features of the person images in the first image to determine the face location in the first image corresponding to the face image obtained from the second image. Thereafter, the face image is set on the face location in the first image.

Accordingly, in the present invention, by using the face recognition, two images are composed to generate a composite image. Moreover, by adjusting the focal length to re-size the person images in the captured image so that the head image of the person can be replaced. Hence, it is a lot of fun for the user to use the image capturing feature of the image capturing apparatus of the present invention.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a process flow diagram, schematically illustrating an image processing method according to a first embodiment of the invention.

FIGS. 2A through 2C are schematic diagrams showing a first image, a second image and a composite image according to the first embodiment of the present invention.

FIG. 3 is a process flow diagram, schematically illustrating an image processing method according to a second embodiment of the present invention.

FIGS. 4A through 4D are schematic diagrams showing a first image, a second image and a composite image according to the second embodiment of the present invention.

### DESCRIPTION OF THE PREFERRED EMBODIMENTS

In the era full of digital cameras, the camera which can take pictures out of ordinary will attracts the users' attentions. Therefore, the present invention provides an image processing method for an image capturing apparatus in which the face recognition is used to generate the delightful composite images. In order to provide a further understanding of the invention, the following embodiments as the applicable exemplars of the present invention are described.

### First Embodiment

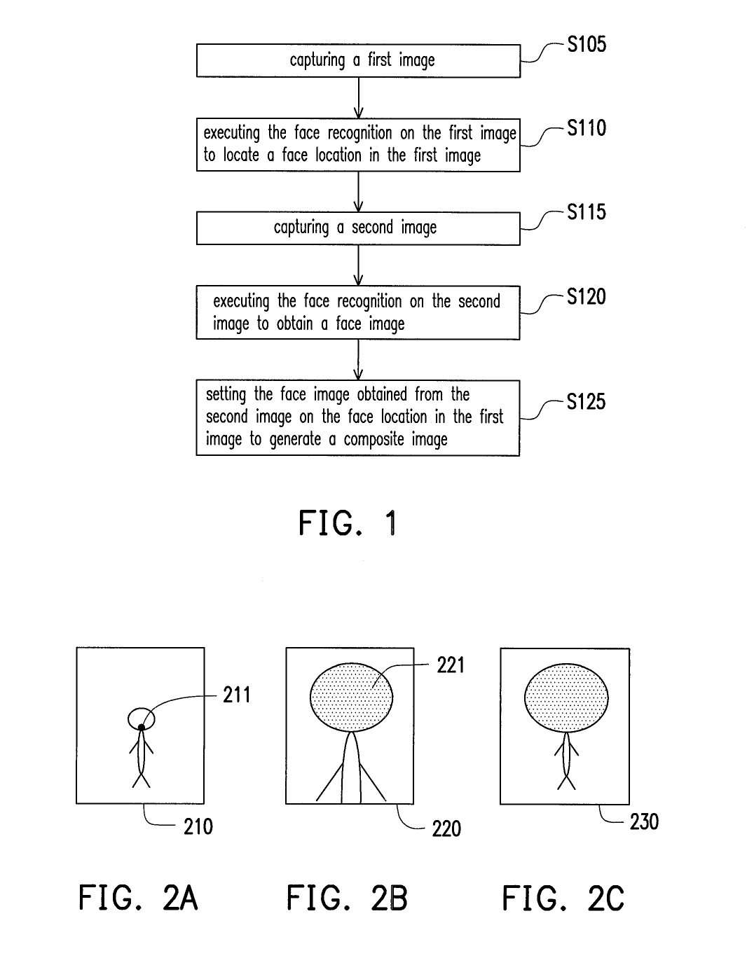

FIG. 1 is a process flow diagram, schematically illustrating an image processing method according to a first embodiment of the invention. In the present embodiment, the image capturing apparatus captures two images and compose the images with the use of the face recognition to generate a composite image. Herein, a first image and a second image are captured under different focal lengths so that the captured frames corresponding to persons to be shot are in different image proportion. For instance, the image capturing apparatus is equipped with a variable-focus lens (i.e. a zoom lens). The image capturing apparatus controls the viewing angle of the captured image and the size of the object image by adjusting the focal length of the variable-focus lens. Generally, the standard focal length is 50 millimeter (mm) which approximates the human viewing angle of about 47 degrees. It should be noticed that the longer the focal length is, the smaller the viewing angle is and the shorter the focal length is, the larger the viewing angle is.

As shown in FIG. 1, in the step S105, a first image is captured by the image capturing apparatus. Herein, while the image capturing apparatus captures the first image, the lens of the image capturing apparatus is adjusted to be at a first focal length. For instance, the user can manually tune the focal length of the image capturing apparatus to be the first focal length and then trigger the camera shutter, to capture the first image. Alternatively, a particular photographing mode can be set in the image capturing apparatus and, when the user switches the image capturing apparatus to the particular photographing mode, the processor of the image capturing apparatus automatically adjusts the focal length of the lens to be the first focal length to capture the first image. In this particular photographing mode, the value of the first focal length can be predetermined.

As shown in FIG. 1, in the step S110, a face recognition is executed on the first image to locate a face location in the first image. There are a lot of well-known face recognition technologies. By using the face recognition, whether a face image exists in the first image can be determined and the face location of the face image in the first image can be located.

Then, in the step S115, a second image is captured by the image capturing apparatus. Herein, while the image capturing apparatus captures the second image, the lens of the image capturing apparatus is adjusted to be at a second focal length. For instance, the user can manually tune the focal length of the image capturing apparatus or the processor of the image capturing apparatus automatically adjusts the focal length of the image capturing apparatus to be the second focal length (the value of which is predetermined in the image capturing apparatus) to capture the second image. Moreover, the user can also directly change the distance between the image capturing apparatus and the person to be shot by directly moving forward or backward so as to adjust the image proportion of the person to be shot in the second image.

Thereafter, in the step S120, the face recognition is executed on the second image to obtain the face image. For instance, after the face image is located, the face image is cut along the profile of the head (including hair) of the face image. Generally, according to the property of the optical zoom, when the focal length is adjust to be the telescope focal length, the differential of the depth of field become obvious. Therefore, when the second image is captured at the telescope focal length, the face image can be more distinguishable from the background so that the image recognition level of the face image is increased. Accordingly, in order to obtain a relatively better face recognition result, the first focal length can be set to be a wide-angle focal length (short focal length) and the second focal length cab be set to be a telescope focal length (long focal length). That is, the first focal length is smaller than the second focal length. For instance, if the zooming range of the variable-focus lens of the image capturing apparatus is 35 mm˜85 mm, the first focal length can be set at 35 mm and the second focal length can be set at 85 mm. Alternatively, the first focal length can be set at 40mm and the second focal length can be set at 70 mm. However, the aforementioned focal length setting are the exemplars and the present invention is not limited thereto.

Finally, in the step S125, the face image obtained from the second image is set on the face location in the first image to generate a composite image. In the present embodiment, the center-bottom of the face image recognized in the first image (such as the chin position) can serve as the face location located by the face recognition. Therefore, the chin position can be used as the attaching basis while the face image obtained from the second image is set on the face location in the first image. Thus, the face image obtained from the second image can be avoided from covering the body image below the neck in the first image. However, it is the exemplar of the present invention and does not limit the scope of the present invention.

Another embodiment is described hereafter for further detailing the process steps of the present invention. FIGS. 2A through 2C are schematic diagrams showing a first image, a second image and a composite image according to the first embodiment of the present invention. Herein, FIG. 2A shows the first image 210 which is captured by the image capturing apparatus at the wide-angle focal length, FIG. 2B shows the second image 220 which is captured by the image capturing apparatus at the telescope focal length and FIG. 2C is a composite image 230 composing the images shown in FIG. 2A and FIG. 2B.

As shown in FIG. 2A, after the face recognition is executed on the first image 210 by the processor of the image capturing apparatus, a face image is recognized and the face location 211 of the recognized face image is located. As shown in FIG. 2B, since the lens is adjusted to be at the telescope focal length to pull the object image visually closer to the image capturing apparatus, the person image in the second image 220 is enlarged. Therefore, it is easy to obtain the face image 221 from the second image. When the processor of the image capturing apparatus performing the image process steps to cut face image 221 from the second image 220, the face image 221 is set on the face location 211 in the first image 210 (herein, the chin of the face image 221 aligns the face location 211) to generate the composite image 230 as shown in FIG. 2C.

When the focal length of the lens is switched to the second focal length, the face image is more distinguishable from the background so that the image recognition level is increased. Moreover, when the second image is captured, the person to be shot can change facial expression. Hence, the variable facial expressions shown in the second image and the enlarged face image in the second image make the composite image more interesting.

Furthermore, whether the first image contains a plurality of persons to be shot can be determined according to the number of the recognized face images in the first image. When the number of the face images is larger than or equal to two, it reveals that the number of the persons to be shot is more than one. The following embodiment is used to describe the steps of the image processing method while the number of the persons to be shot is more than one.

### Second Embodiment

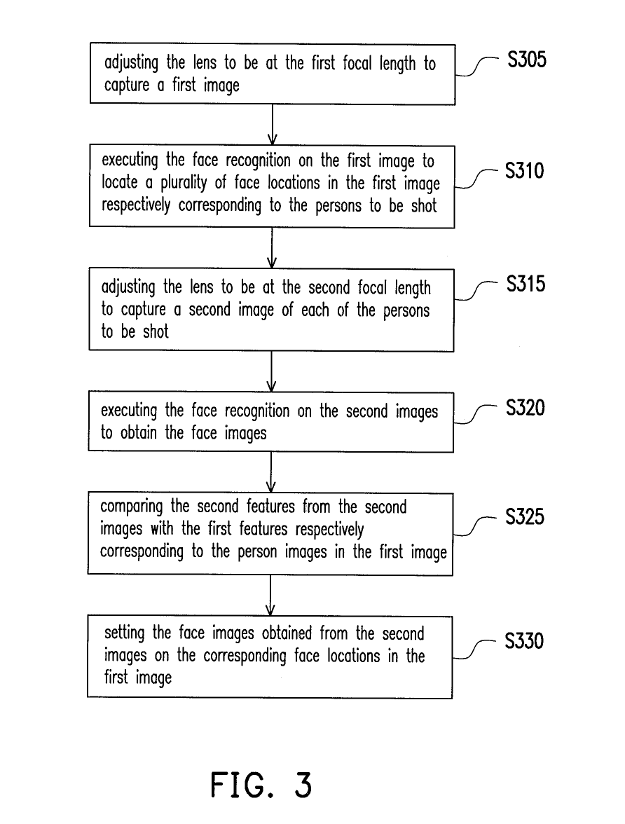

FIG. 3 is a process flow diagram, schematically illustrating an image processing method according to a second embodiment of the present invention. As shown in FIG. 3, in the step S305, the lens of the image capturing apparatus is adjusted to be at the first focal length (such as the wide-angle focal length) to capture the first image. Then, in the step S310, the image recognition is executed on the first image to respectively locate a plurality of face locations in the first image respectively corresponding to the persons to be shot.

Herein, according to the number of the recognized face images in the first image, whether there are a plurality of person images in the first image can be determined. That is, when the number of the face images in the first image is larger than or equal to two, it reveals that the first image contains a plurality of person images corresponding to a plurality of persons to be shot. After the person images respectively corresponding to the persons to be shot are recognized, a first facial feature corresponding to each of the person images in the first image is stored and the face location of each of the person images in the first image is stored as well. For instance, if the number of the persons to be shot is two, there are two face images recognized in the first image. Then, the first facial feature of each of the person images corresponding to the persons to be shot is stored and the face location of each of the person images corresponding to the persons to be shot is stored.

Thereafter, in the step S315, the lens is adjusted to be at the second focal length (such as the telescope focal length) to capture the second image of each of the persons to be shot. For instance, if the number of the persons to be shot is two, the second images of the persons to be shot are individually captured by the image capturing apparatus at the second focal length. That is, two second images respectively corresponding to the two persons to be shot are obtained.

Then, in the step S320, the face recognition is executed on the second image to obtain face image. Also, a second facial feature of the face image is stored. Since the first image contains a plurality of person images corresponding to a plurality of persons to be shot, the face locations in the first image respectively corresponding to the face images in the second images can be located by comparing the facial features in the first image with the facial features in the second images.

Thereafter, in the step S325, by comparing the second facial features obtained from the second images with the first facial features corresponding to the person images in the first facial images, the face locations in the first image respectively corresponding to the face images obtained from the second images can be located. Then, after the face locations in the first image corresponding to the face images are located, in the step S330, the face images are respectively set on the face locations to generate the composite image.

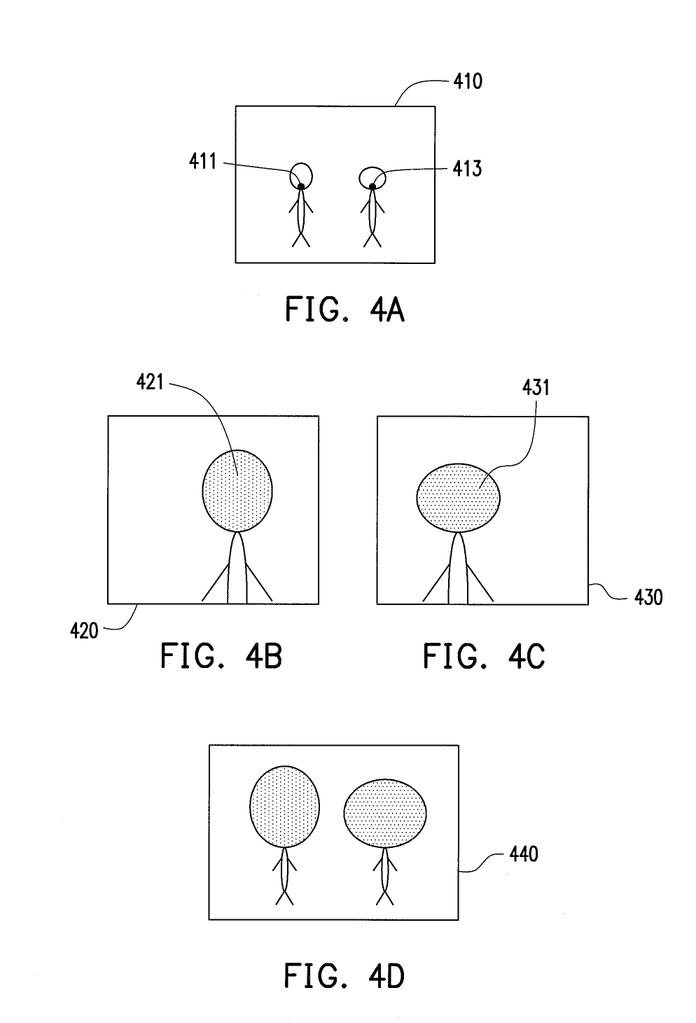

The other exemplar is described hereafter. FIGS. 4A through 4D are schematic diagrams showing a first image, a second image and a composite image according to the second embodiment of the present invention. In the present embodiment, it is assumed that the image capturing apparatus is used to capture the image of persons A and B. FIG. 4A is the first image 410 captured by the image capturing apparatus at the wide-angle focal length. FIG. 4B and FIG. 4C are the second images 420 and 430 of the persons (corresponding to the person images shown in the first image 410) respectively captured by the image capturing apparatus at the telescope focal length. FIG. 4D are the composite image generated by cutting the face images 421 and 431 respectively from the second images 420 and 430 and setting the face images 421 and 431 on the corresponding face locations 411 and 413.

In the FIG. 4A, after the processor of the image capturing apparatus executes the face recognition on the first image 410, two face images can be recognized and the face locations 411 and 413 respectively corresponding to the face images are located. Herein, it is assumed that the face location 411 is corresponding to the person A and the face location 413 is corresponding to the person B. Thereafter, the lens is adjusted to be at the telescope focal length to pull the object image visually closer to the image capturing apparatus and the second image 420 of the person A and the second image 430 of the person B are respectively captured as shown in FIG. 4B and FIG. 4C.

Then, the processor of the image capturing apparatus cuts the face image 421 in the second image 420 and compares the second facial feature of the face image 421 with the two first facial features in the first image to locate the face location 411 corresponding to the face image 421. Then, the face image 421 is set on the face location 411 in the first image 410. Moreover, the processor of the image capturing apparatus cuts the face image 431 in the second image 430 and compares the second facial feature of the face image 431 with the two facial features in the first image to locate the face location 413 corresponding to the face image 431. Then, the face image 431 is set on the face location 413 in the first image 410. Accordingly, the composite image 440 is generated.

Hence, in the present invention, the face recognition function and the image capturing apparatus equipped with the variable-focus lens are used to generate interesting composite image. Further, when the lens of the image capturing apparatus is switched to be at the telescope focal length, the face image corresponding to the person to be shot is more distinguishable from the background so that the image recognition level is increased. Also, since the face image is enlarged, it makes the composite image more interesting.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An image processing method for an image capturing apparatus, the method comprising:
capturing a first image;
executing a face recognition on the first image to locate a face location in the first image;
capturing a second image;
executing the face recognition on the second image to obtain a face image; and
generating a composite image by setting the face image on the face location in the first image.

2. The image processing method of claim 1, wherein
the step of capturing the first image comprises:
adjusting a lens of the image capturing apparatus to a first focal length to capture the first image;
the step of capturing the second image comprises:
adjusting the lens to a second focal length to capture the second image.

3. The image processing method of claim 2, wherein the first focal length is a wide-angle focal length and the second focal length is a telescope focal length.

4. The image processing method of claim 1, after the step of executing the face recognition on the first image, further comprising:
determining whether the first image comprises a plurality of person images respectively corresponding to a plurality of persons according to a number of face images recognized in the face recognition executed on the first image.

5. The image processing method of claim 4,
when the number of the face images recognized in the face recognition executed on the first image is larger than or equal to two, further comprising:
storing a first facial feature corresponding to each of the person images in the first image; and
storing the face location corresponding to each of the person images in the first image.

6. The image processing method of claim 5, wherein when the number of the face images recognized in the face recognition executed on the first image is larger than or equal to two, the step of capturing the second image further comprises:
capturing the second image of each of the persons.

7. The image processing method of claim 5, after the step of executing the face recognition on the second image to obtain the face image corresponding to each of the persons, further comprising:
storing a second facial feature of each of the face images.

8. The image processing method of claim 7, before the step of setting the face image on the face location in the first image, further comprising:
comparing the second facial features obtained from the second images with the first facial features of the person images in the first image to locate the face locations in the first image respectively corresponding to the face images.

9. The image processing method of claim 8, wherein the step of setting the face images on the face location in the first image comprises:
after the face locations in the first image corresponding to the face images are located, setting the face images on the corresponding face locations in the first image.
